(19) United States
(12) Patent Application Publication
(10) Pub. No.: US 2015/0199396 A1
(43) Pub. Date: Jul. 16, 2015

(54) METHOD FOR VALIDATING THE INTEGRITY OF A STYLE SHEET

(71) Applicants: Mike Curtis, San Francisco, CA (US); Ian Tinkham McCabe Flanigan, Zurich (CH); Daniel Felix Pupius, San Francisco, CA (US)

(72) Inventors: Mike Curtis, San Francisco, CA (US); Ian Tinkham McCabe Flanigan, Zurich (CH); Daniel Felix Pupius, San Francisco, CA (US)

(73) Assignee: Google Inc., Mountain View, CA (US)

(21) Appl. No.: 13/462,741

(22) Filed: May 2, 2012

(51) Int. Cl. G06F 17/30; G06F 17/22

(52) U.S. Cl. CPC G06F 17/30371; G06F 17/2247; G06F 17/30876

(57) ABSTRACT

A system and method for validating the integrity of a style sheet. A request is received for a style sheet from a web browser. The style sheet is determined based on the request. A marker is placed at an end of the style sheet denoting the end of the style sheet, and the style sheet is sent containing the marker to the web browser. The web browser checks the style sheet for the placed marker.

### BACKGROUND

1. Field

The present disclosure generally relates to the use of style sheets in web pages, and more particularly to validating the integrity of a style sheet.

2. Description of the Related Art

Some current web pages use cascading style sheets to enhance the appearance of a web page. An error may occur in formatting a web page if an error occurs in transmission of the style sheet from a server to a client.

### SUMMARY

The disclosed subject matter relates to validating the integrity of a style sheet. The method includes receiving a request for the style sheet from a web browser and determining the style sheet based on the request. The method may also include placing a marker at an end of the style sheet denoting the end of the style sheet and sending the style sheet containing the marker to the web browser.

A method of validating the integrity of a style sheet includes sending a request for a style sheet to a server and receiving the style sheet from the server, the style sheet comprising plural rules. The method may also include checking the style sheet for a marker placed in the style sheet denoting the end of the style sheet and sending an indication to a server that an error has occurred, if there is no marker placed in the style sheet.

The disclosed subject matter further relates to a system for validating the integrity of a style sheet. The system includes one or more processor(s) and a memory containing processor executable instructions. When executed by the processor(s), the system receives a request for the style sheet from a web browser and determines the style sheet based on the request. The system also places a marker at the end of the style sheet denoting the end of the style sheet, wherein the style sheet is capable of being checked by the web browser for the presence of the marker. The system further sends the style sheet containing the marker to the web browser and receives an indication that an error has occurred, if there is no marker placed at the end of the style sheet.

The disclosed subject matter also relates to a machine-readable storage medium comprising machine-readable instructions for validating the integrity of a style sheet. The method includes receiving a request for a plurality of style sheets from a web browser and determining the plurality of style sheets based on the request. The method further includes placing a respective marker at the end of each style sheet of the plurality of style sheets, each marker denoting the end of each style sheet and sending each style sheet containing each marker to the web browser.

The disclosed subject matter also relates to a machine-readable storage medium comprising machine-readable instructions for validating the integrity of a style sheet, the method including sending a request for a plurality of style sheets to a server and receiving the plurality of style sheets, wherein each style sheet of the plurality of style sheets comprises plural rules. The method further includes checking each style sheet for a respective marker placed in each style sheet denoting the end of each respective style sheet and sending an indication to a server that an error has occurred, if there is no marker placed in any single style sheet of the plurality of style sheets.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example system for validating the integrity of a style sheet.

FIG. 2 is a block diagram illustrating an example client and server from the system of FIG. 1.

FIG. 3a-FIG. 3c illustrate example processes for validating the integrity of a style sheet.

FIG. 4 is a flow diagram as it relates to aspects of the subject technology.

FIG. 5 is a block diagram illustrating an electronic system with which some implementations of the subject technology are implemented.

### DETAILED DESCRIPTION

In the following detailed description, numerous specific details are set forth to provide a full understanding of the subject technology. It will be apparent, however, that different aspects of the subject technology may be practiced without some of these specific details. In other instances, well-known structures and techniques have not been shown in detail so as not to obscure the disclosure.

The disclosed subject matter describes systems and techniques for validating the integrity of a style sheet. The integrity of the style sheet is validated by checking the last rule of a style sheet that is sent from a server to a client. The server places a marker at the end of the style sheet for the checking procedure. The marker may be an empty rule. The marker may be a rule that contains additional information associated with the style sheet. If the last rule of the style sheet is determined to be the marker placed by the server, then the integrity of the style sheet has been validated. If the last rule of the style sheet is not the marker, then the web browser of the client may send an error message to the server to indicate that the marker was not detected at the end of the style sheet. The error message thus indicates that the integrity of the style sheet has been compromised in the transmission of the style sheet from the server to the client.

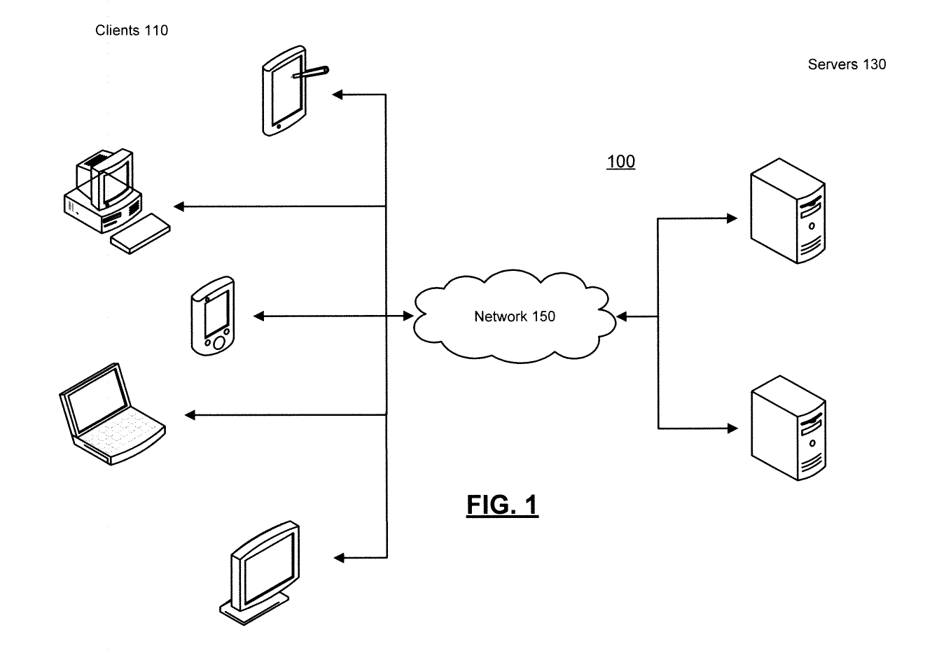

Turning to the drawings, FIG. 1 illustrates an example system 100 for validating the integrity of a style sheet. The system 100 includes clients 110 and servers 130 connected over a network 150.

The system 100 is comprised of client(s) 110, server(s) 130 and the network 150 in any combination or configuration that allows for the validating of the integrity of a style sheet, including implementations with multiple servers 130. Each of the clients 110 can be, for example, desktop computers, laptop computers, mobile devices (e.g., a smartphone, tablet computer, or PDA), set top boxes (e.g., for a television), video game consoles, or any other devices having an appropriate processor, memory, and communications capabilities. In certain instances, different versions and/or configurations of the system that include subject technology as disclosed herein are available for download from a server 130 and subsequent installation on client 110. The servers 130 can be any device having a processor, memory, and communications capability for hosting the data for installing and hosting the system. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a ring network, a mesh network, a star-bus network, tree or hierarchical network, and the like.

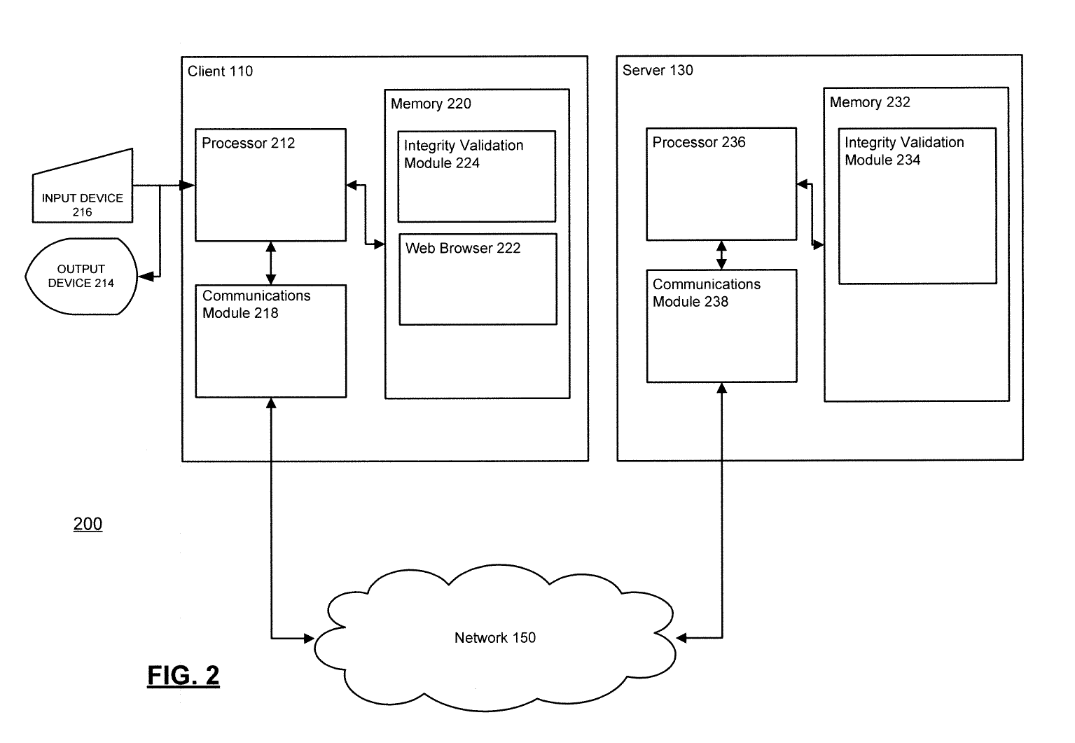

FIG. 2 is a block diagram illustrating an example client and server from the system 100 of FIG. 1. The client 110 and the server 130 are connected over the network 150 via respective communications modules 218 and 238 and are configured to interface with the network 150 to send and receive information, such as data, requests, responses, and commands to other devices on the network. The communications modules 218 and 238 can be, for example, modems or Ethernet cards.

The client 110 includes a processor 212, a communications module 218, and a memory 220 that may include an integrity validation module 224 and a web browser 222. Integrity validation module 224 may include web browser 222 or may be a separate module within memory 220.

The processor 212 of the client 110 is configured to execute instructions, such as instructions physically coded into the processor 212, instructions received from software in memory 220, or a combination of both. For example, the input device 216 may provide textual information to processor 212 which is processed by an integrity validation module 224 stored in memory 220. The textual information may then be sent through network 150 via communications module 218 to server 130, which receives the information through communications module 238.

Server 130 includes a processor 236, a communications module 238, and a memory 232 that may include an integrity validation module 234.

Processor 236 is configured to execute instructions, such as instructions physically coded into the processor 236, instructions received from software in memory 232, or a combination of both.

Processor 236 processes information from integrity validation module 234 and sends information through communications module 238, through network 150, to client 110 to be displayed on output device 214.

Integrity validation module 234 may be capable of placing a marker in a style sheet. The integrity validation module 234 is additionally configured to support and respond to requests from web browser 222 contained in client 110. Web browser 222 may be included in integrity validation module 224 or may be a separate module within memory 220 of client 110.

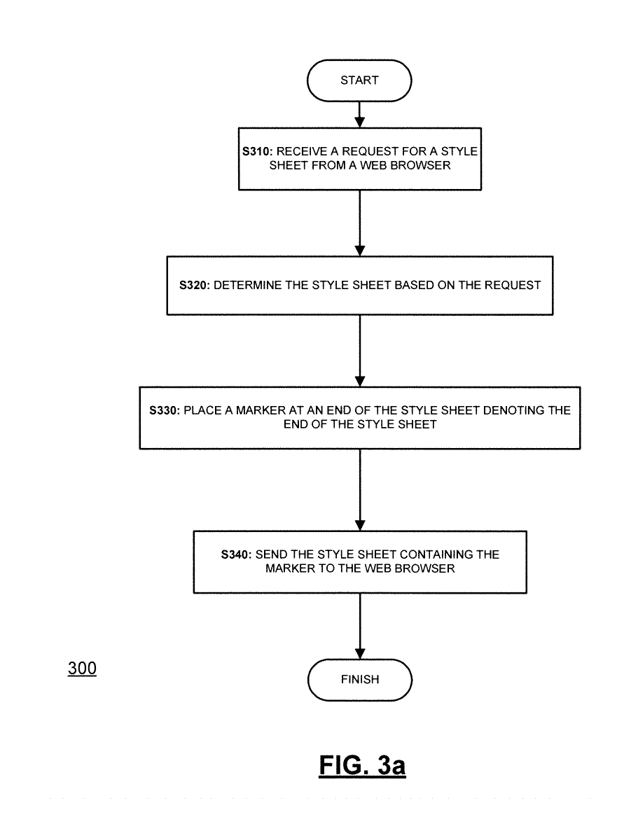

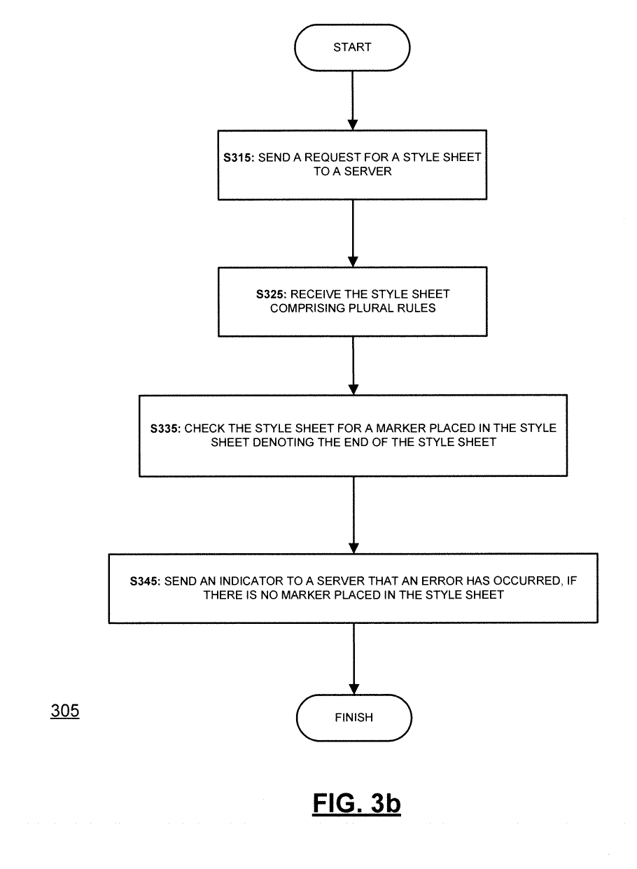

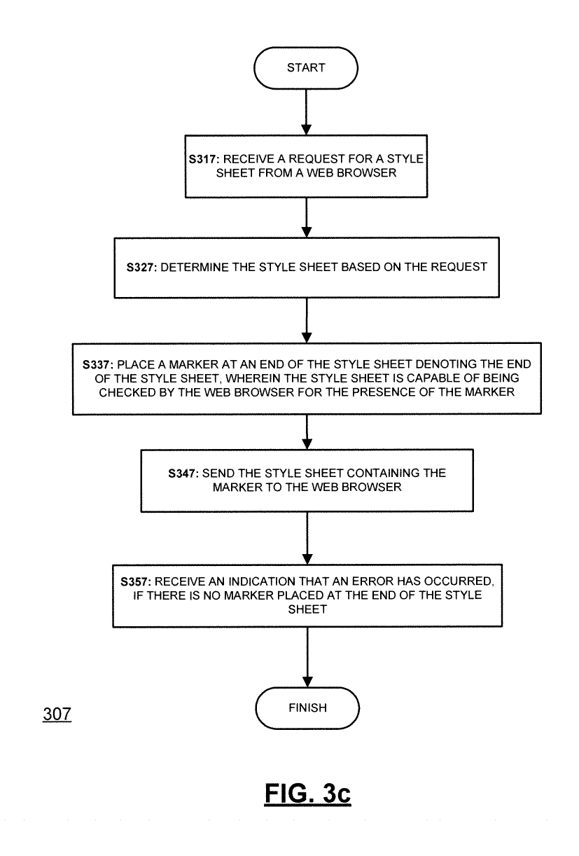

FIG. 3a illustrates an example process 300 for validating the integrity of a style sheet as shown by the example client 110 and server 130 of FIG. 2 that can provide for validating the integrity of a style sheet. Although process 300 of FIG. 3a is described with reference to FIG. 2, the process 300 is not limited to such a configuration and can be applied to other systems and configurations.

The process begins with step S310, when a server 130 receives a request for a style sheet from a web browser 222 of client 110. This step may be preceded by a user requesting a web page by providing a uniform resource locator (URL) or other identifier that allows for the provision of a web page. The user may request a web page by clicking a link on a currently displayed web page. A request for a web page may originate from client 110, by virtue of direction or redirection from a current web page. The web browser 222 of client 110 may then request a style sheet upon the rendering of the requested web page.

In step S320, the server 130 determines the style sheet based on the request, and in step S330, the server 130 places a marker at an end of the style sheet denoting the end of the style sheet. The marker may consist of an empty rule that does not provide formatting information to web browser 222 when the web page is rendered or may otherwise take the form of a character string. The marker may be distinct from rules or other text strings that provide formatting information to a web browser and may be placed as a last rule following a plurality of rules in the style sheet. If multiple style sheets are requested, a marker may be placed in each style sheet. A style sheet that will be split into multiple sub-style sheets prior to transmission to the client 110 may have a marker placed at the end of each sub-style sheet prior to transmission. Therefore, a web browser that subsequently identifies the marker will carry a low chance of identifying a preexisting rule or text string that was not placed by the server for the purposes of validating the integrity of the style sheet.

The marker may contain information associated with the style sheet in which it is placed. Information located in the marker may be deter mined by the server and may include any one or combination of: the length of the style sheet, the total number of rules in the style sheet, a floating point value associated with the style sheet, or a value that may be used to further evaluate the integrity of the style sheet. The value that may be used to further evaluate the integrity of the contents of the style sheet may be a checksum value or cyclic redundancy check (CRC) value. The marker may also include information related to the style sheet such as a cutpoint for separating the style sheet into multiple sub-style sheets. The marker may be placed in a sub-style sheet or other style sheet that is associated with multiple style sheets. The marker may then contain information relating to the associated other style sheets.

The server 130 may place the marker at the end of the style sheet as a last rule of the style sheet. In the process of placing the marker at the end of the style sheet, the server 130 may determine the length of the style sheet, determine the total number of rules in the style sheet, determine a checksum value, and determine a floating point value associated with the style sheet at the server. The determined number of total rules in the style sheet may include the marker, or the determined number of total rules in the style sheet may not include the marker. The marker may be placed at the end of the style sheet, and information for the marker may be determined when a style sheet is initially uploaded to a server 130, may be performed following a request by a web browser 222 of client 110 for the style sheet, or the like.

The process ends in step S340, when the server 130 sends the style sheet containing the marker to the web browser 222 of client 110. A style sheet that has been previously received from server 130 including the marker previously placed by server 130 may be cached by client 110 and used with later requests for the same style sheet. A style sheet that has been previously received from server 130 (including the marker that is associated with the style sheet) may be accessed from cache by the web browser 222 upon subsequent requests for the style sheet.

Steps of process 300 may be combined with other processes disclosed herein, and may be performed in tandem with steps of process 305. FIG. 3b illustrates an example process 305 for validating the integrity of a style sheet as shown by the example client 110 and server 130 of FIG. 2 that can provide for validating the integrity of a style sheet. Although process 305 of FIG. 3b is described with reference to FIG. 2, the process 305 is not limited to such a configuration and can be applied to other systems and configurations.

The process begins with step S315, in which the web browser 222 of client 110 sends a request for a style sheet to a server. In step S325, web browser 222 of client 110 receives the style sheet comprising plural rules. The style sheet may be sent by server 130 or accessed from the cache of web browser 222 from a previously sent style sheet from server 130. The style sheet received by the web browser 222 is a style sheet in which the server 130 has placed the marker at the end of the style sheet prior to transmission from the server 130 to the web browser 222.

In step S335, the web browser 222 of client 110 checks the style sheet for a marker placed in the style sheet denoting the end of the style sheet. The check may be performed as a check of the last rule of the style sheet. The check may be conducted based on instructions written into the web page that instruct the web browser 222 to search for the marker as a text string. The web browser 222 may check the entire contents of the style sheet for the marker or selectively check portions of the style sheet.

The process ends in step S345 when the client 110 sends an indication to a server 130 that an error has occurred if there is no marker placed in the style sheet. The indication may consist of an error message. If additional evaluations are performed to validate the integrity of the style sheet (such as a checksum algorithm using a checksum value stored in the marker), the error message may include information relating to all evaluation results. The client 110 may send an indication to a server 130 that an error has occurred if any evaluation detects an error in the style sheet, regardless of whether the marker is detected in the style sheet. The web browser 222 may send the error message to the sending server 130 or another server 130 indicating that an error has occurred. The error message may contain information identifying the style sheet and other information associated with the transmission of the style sheet. The web page may be rendered with the style sheet regardless of whether an error message is sent.

FIG. 3c illustrates an example process 307 for validating the integrity of a style sheet as shown by the example client 110 and server 130 of FIG. 2 that can provide for validating the integrity of a style sheet. Although process 307 of FIG. 3c is described with reference to FIG. 2, the process 307 is not limited to such a configuration and can be applied to other systems and configurations.

The process begins with step S317, in which server 130 receives a request for a style sheet from web browser 222 of client 110. A web page may contain a link tag causing the web browser 222 to request the style sheet from server 130.

In step S327, the server 130 determines the style sheet based on the request from the web browser 222 of client 110. In step S337, the server 130 places a marker at an end of the style sheet denoting the end of the style sheet, wherein the style sheet is capable of being checked by the web browser for the presence of the marker. The server may include additional information in the marker that is determined prior to or concurrently with placing the marker at the end of the style sheet.

In step S347, the server 130 sends the style sheet containing the marker to the web browser 222 of client 110. Following step S347 web browser 222 may receive the style sheet from server 130. As the web browser 222 associates the style sheet with the web page for formatting the web page, web browser 222 may check the style sheet for the marker placed in the style sheet by the server 130. If the web browser 222 detects the marker, then the integrity of the style sheet has been validated. Rendering of the web page is then completed and may be provided for display to output device 214 of client 110.

The process ends in step S357 in which the server 130 receives an indication that an error has occurred, if there is no marker placed at the end of the style sheet. The web browser 222 may complete the rendering of the web page based on the style sheet that was received by the client 110 and provide the partially formatted web page for display to output device 214 of client 110.

Regardless of whether the web browser 222 determines that the marker is the last rule of the style sheet, the web browser 222 renders the page with the instructions that are present in the style sheet as it was transmitted from server 130. The web page may be rendered with errors.

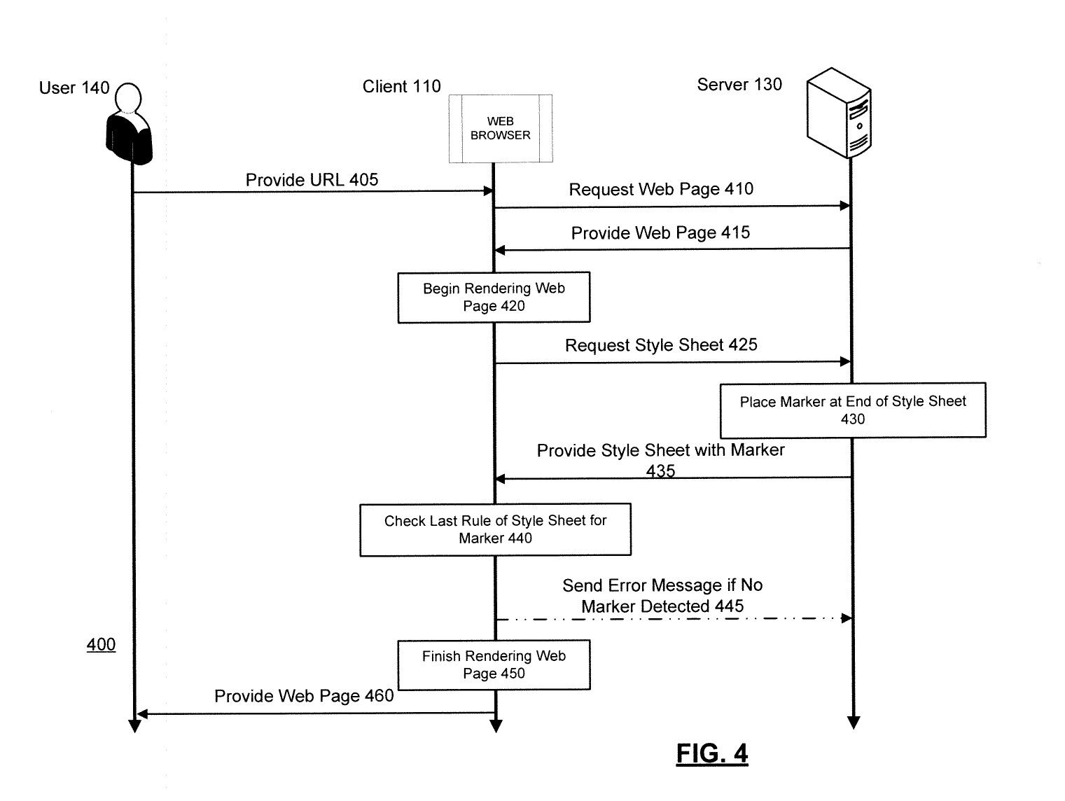

FIG. 4 is a flow diagram relating to the example processes of FIGS. 3a-3c. FIG. 4 illustrates an example flow process 400 for validating the integrity of a style sheet as shown by the example client 110 and server 130 of FIG. 2 and a user 140 that can provide for the validation of the integrity of a style sheet. Although process 400 of FIG. 4 is described with reference to FIG. 2 and is associated with some steps initially referenced in FIGS. 3a-3c, the process 400 is not limited to such configurations and processes and can be applied to other systems, configurations, and processes.

As shown in FIG. 4, user 140 may provide a URL 405, or other identifier of a web page to client 110. The URL may be provided via an input device 216 of client 110 such as a keyboard. The URL may be provided to the client 110 by an input device 216 such as a mouse, by selecting a URL or a hyperlink of a web page that is being displayed to a user. A URL may additionally be provided in the form of a rerouted link from another URL.

The web browser 222 of client 110 may then request the web page 410 from server 130, and the server 130 provides the requested web page 415 to the web browser 222 of client 110. The web browser 222 begins formatting or rendering the web page 420 and requests a cascading style sheet (style sheet) 425 from server 130. Server 130 places a marker at the end of the style sheet 430 and provides the style sheet with the marker 435 to the web browser 222. The web browser 222 of client 110 then checks the last rule of the style sheet 440 for the presence of the marker. If the marker is not detected or found in the style sheet, an error message is sent 445 from the web browser 222 to the server 130. Regardless of whether the marker is found in the style sheet or whether an error message is sent to the server 130, the rendering of the web page is completed 450 by the web browser 222 and the web page is then provided for display 460 via output device 214 to user 140.

Many of the above-described features and applications are implemented as software processes that are specified as a set of instructions recorded on a computer readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject technology can be implemented as sub-parts of a larger program while remaining distinct software aspects of the subject technology. In some implementations, multiple software aspects can also be implemented as separate programs. Finally, any combination of separate programs that together implement a software aspect described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

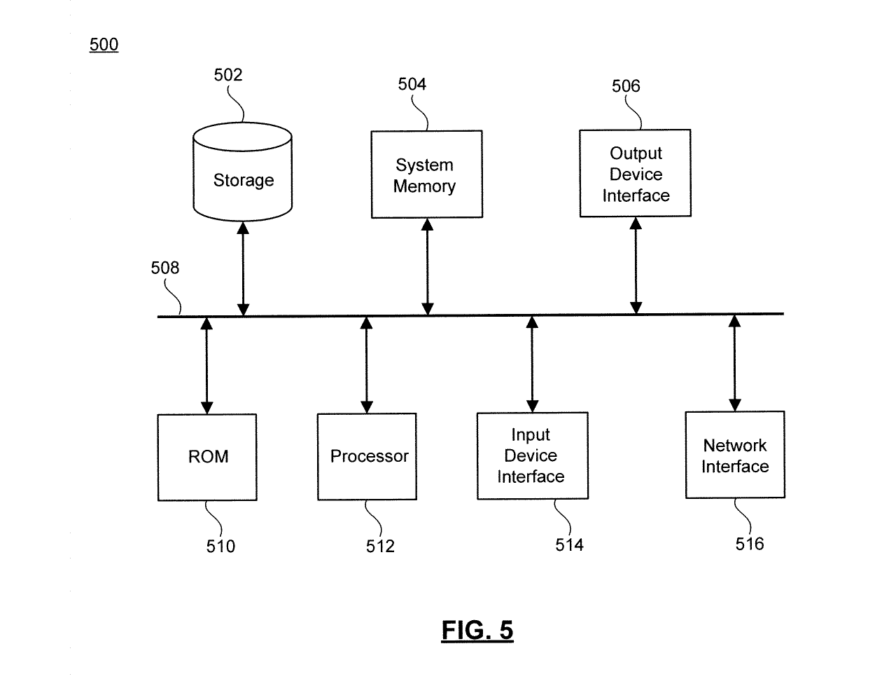

FIG. 5 conceptually illustrates an electronic system with which some implementations of the subject technology are implemented. Electronic system 500 can be a computer, phone, PDA, or any other sort of electronic device. Such an electronic system includes various types of computer-readable media and interfaces for various other types of computer-readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject technology. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject technology use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores some of the instructions and data that the processor needs at runtime. In some implementations, the processes of the subject technology are stored in system memory 504, permanent storage device 502, and/or ROM 510. For example, the various memory units include instructions for providing for validating the integrity of a style sheet in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interface 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers such as a local area network (“LAN”), a wide area network (“WAN”), or an Intranet, or a network of networks, such as the Internet. Any or all components of electronic system 500 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Aspects of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for validating the integrity of a style sheet, the method comprising:
receiving a request for the style sheet from a web browser;
determining the style sheet based on the request;
placing a marker comprising an empty rule at an end of the style sheet denoting the end of the style sheet, the marker including a cutpoint for separating the style sheet into multiple sub-style sheets, the marker configured for validating the integrity of the style sheet; and
sending the style sheet containing the marker to the web browser.

2. The method of claim 1, wherein the style sheet comprises plural rules, and wherein the marker corresponds to a last rule of the plural rules in the style sheet.

3. The method of claim 1, wherein the step of placing further comprises:
determining a length of the style sheet;
determining a total number of rules in the style sheet, the total number of rules including the marker;
determining a checksum value associated with the style sheet; and
writing in the marker the determined length of the style sheet, the determined total number of rules in the style sheet, and the determined checksum value associated with the style sheet.

4. (canceled)

5. The method of claim 1, wherein the request is for a plurality of style sheets and wherein a respective marker is placed at the end of each style sheet of the plurality of style sheets.

6. A computer-implemented method for validating the integrity of a style sheet, the method including:
sending a request for the style sheet to a server;
receiving the style sheet from the server, the style sheet comprising plural rules;
determining if there is a marker placed in the style sheet denoting the end of the style sheet, the marker comprising an empty rule and a cutpoint for separating the style sheet into multiple sub-style sheets;
if it is determined that the marker is placed in the style sheet, validating the integrity of the style sheet; and
if it is determined that the marker is not placed in the style sheet, sending an indication to a server that an error has occurred.

7. The method of claim 6, wherein the marker is placed as a last rule of the plural rules in the style sheet.

8. The method of claim 6, wherein the marker contains information including a length of the style sheet, the total number of rules in the style sheet, or a floating point value associated with the style sheet.

9. (canceled)

10. The method of claim 6, wherein the request is for a plurality of style sheets from the server and wherein a respective marker is placed at the end of each style sheet of the plurality of style sheets.

11. A system for validating the integrity of a style sheet, the system comprising:
one or more processors; and
a memory containing processor-executable instructions that, when executed by the one or more processors, cause the system to:
receive a request for the style sheet from a web browser;
determine the style sheet based on the request;
place a marker comprising an empty rule at an end of the style sheet denoting the end of the style sheet, the marker including a cutpoint for separating the style sheet into multiple sub-style sheets, the marker configured for validating the integrity of the style sheet, wherein the style sheet is configured to be checked by the web browser for the presence of the marker;
send the style sheet containing the marker to the web browser; and
receive an indication that an error has occurred if the style sheet is received by the web server without the marker.

12. The system of claim 11, wherein the style sheet comprises plural rules, and wherein the marker corresponds to a last rule of the plural rules in the style sheet.

13. The system of claim 11, wherein the system is caused to place by further causing the system to:
determine a length of the style sheet;
determine a total number of rules in the style sheet including the marker;
determine a floating point value associated with the style sheet;
determine a checksum value associated with the style sheet; and
write in the marker the determined length of the style sheet, the determined total number of rules in the style sheet including the marker, the determined floating point value, and the determined checksum value, associated with the style sheet.

14. (canceled)

15. The system of claim 11, wherein the request is for a plurality of style sheets and wherein a respective marker is placed at the end of each style sheet of the plurality of style sheets.

16. A non-transitory machine-readable storage medium comprising machine-readable instructions for validating the integrity of a style sheet, the method including:
receiving a request for a plurality of style sheets from a web browser;
determining the plurality of style sheets based on the request;
placing a marker comprising an empty rule at an end of each style sheet of the plurality of style sheets, each marker denoting the end of each style sheet, wherein at least one marker includes a cutpoint for separating the corresponding style sheet into multiple sub-style sheets; and
sending each style sheet containing each marker to the web browser, each marker configured for validating the integrity of the corresponding style sheet.

17. The non-transitory machine-readable storage medium of claim 16,
wherein each style sheet of the plurality of style sheets comprises plural rules, and wherein each marker of each style sheet corresponds to a last rule of the plural rules in each style sheet.

18. The non-transitory machine-readable storage medium of claim 16, wherein each marker comprises information including a length of the style sheet, the total number of rules in the style sheet, and a floating point value associated with the style sheet.

19. (canceled)

20. A non-transitory machine-readable storage medium for validating the integrity of a style sheet, the method including:
sending a request for a plurality of style sheets to a server;
receiving the plurality of style sheets from the server, wherein each style sheet of the plurality of style sheets comprises plural rules;
determining if there is a respective marker placed in each style sheet denoting the end of each respective style sheet, at least one respective marker comprising an empty rule and a cutpoint for separating the style sheet into multiple sub-style sheets; and
sending an indication to a server that an error has occurred if it is determined that no marker is placed in any single style sheet of the plurality of style sheets.

21. The non-transitory machine-readable storage medium of claim 20, wherein each marker of the plurality of style sheets is placed as the last rule of the plural rules in each style sheet.

22. The non-transitory machine-readable storage medium of claim 20, wherein the marker of each style sheet of the plurality of style sheets contains information associated with that style sheet including a length of that style sheet, the total number of rules in that style sheet, and a floating point value associated with that style sheet.

23. (canceled)

24. The method of claim 1, wherein the style sheet is associated with other style sheets, the marker comprising information related to the associated other style sheets.
